(19) United States
(12) Patent Application Publication
(10) Pub. No.: US 2021/0056568 A1
(43) Pub. Date: Feb. 25, 2021

(54) Product Detection Method and Product Detection System Capable of Detecting an Event of a Product for Determining a Sales Status

(71) Applicant: QISDA CORPORATION, Taoyuan City (TW)

(72) Inventors: Chun-Chin Chen, Taoyuan City (TW); Cheng-Te Tseng, Taoyuan City (TW)

(21) Appl. No.: 16/987,432

(22) Filed: Aug. 7, 2020

(30) Foreign Application Priority Data
Aug. 20, 2019 (CN) 201910768408.6

(51) Int. Cl. G06Q 30/02; G06Q 10/08; G06T 7/73; G06K 9/00; H04N 7/18

(52) U.S. Cl. CPC G06Q 30/0201; G06Q 10/087; H04N 7/18; G06K 9/00624; G06T 7/73

(57) ABSTRACT

A product detection method includes acquiring an image including a shelf laminate and a plurality of products placed on the shelf laminate, acquiring position information of a product of the plurality of products according to the image, detecting an event of the product by using a plurality of sensors adjacent to the shelf laminate for generating a plurality of detection results, and determining a sales status of the product according to the position information of the product disposed on the shelf laminate and the plurality of detection results.

### BACKGROUND OF THE INVENTION

### 1. Field of the Invention

The present invention discloses a product detection method and a product detection system, and more particularly, a product detection method and a product detection system capable of detecting an event of a product for determining a sales status of the product.

### 2. Description of the Prior Art

With the rapid developments of technologies, purchasing various products and logistic services has become more and more convenient for consumers. Many convenience stores, shopping malls, or grocery stores have a plurality of shelves. Each shelf contains at least one laminate for placing various products. In order to display names and selling prices of products for the consumers, traditional shelves use a manual method for placing at least one notepaper near corresponding products. The notepapers can list sales information, product information, special information, and discount periods. When a user wants to buy a product, the user has to look for the notepapers having sales messages before the user decides if he/she really needs to purchase this product.

In order to reduce a cost of consumables and increase purchasing convenience, some advanced shelves can include display devices for displaying sales information and/or promotional information of the products placed on the shelves. However, although the sales information and/or the promotional information can be intuitively understood by consumers, a sales status of each product placed on the shelf still needs to be checked or manually managed by the service staff. For example, statistical data of popularity, sales, attention of the products disposed on the shelves are determined by the service staff or manually recorded by the service staff when a patrolling process is executed by the service staff. Therefore, currently, the service staff has to spend a lot of manpower and recording time for managing the sales status of the products disposed on the shelves.

### SUMMARY OF THE INVENTION

In an embodiment of the present invention, a product detection method is disclosed. The product detection method comprises acquiring an image comprising a shelf laminate and a plurality of products placed on the shelf laminate, acquiring position information of a product of the plurality of products according to the image, detecting an event of the product by using a plurality of sensors adjacent to the shelf laminate for generating a plurality of detection results, and determining a sales status of the product according to the position information of the product disposed on the shelf laminate and the plurality of detection results.

In another embodiment of the present invention, a product detection system is disclosed. The product detection system comprises a shelf laminate, a plurality of sensors, a transmitter, and a processor. The shelf laminate is configured to place a plurality of products. The transmitter is configured to transmit and receive data. The processor is coupled to the plurality of sensors and the transmitter and configured to control the plurality of sensors and the transmitter. After the processor acquires an image comprising the shelf laminate and the plurality of products placed on the shelf laminate, the processor acquires position information of a product of the plurality of products according to the image. The processor controls the plurality of sensors for detecting an event of the product for generating a plurality of detection results. The processor determines a sales status of the product according to the position information of the product disposed on the shelf laminate and the plurality of detection results.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a product detection system according to an embodiment of the present invention.

FIG. 2 is an illustration of a linear sensor array and an allocation range of products placed on a shelf laminate of the product detection system in FIG. 1.

FIG. 3 is an illustration of a gesture of picking up a product in the product detection system in FIG. 1.

FIG. 4 is a flow chart of a product detection method performed by the product detection system in FIG. 1.

### DETAILED DESCRIPTION

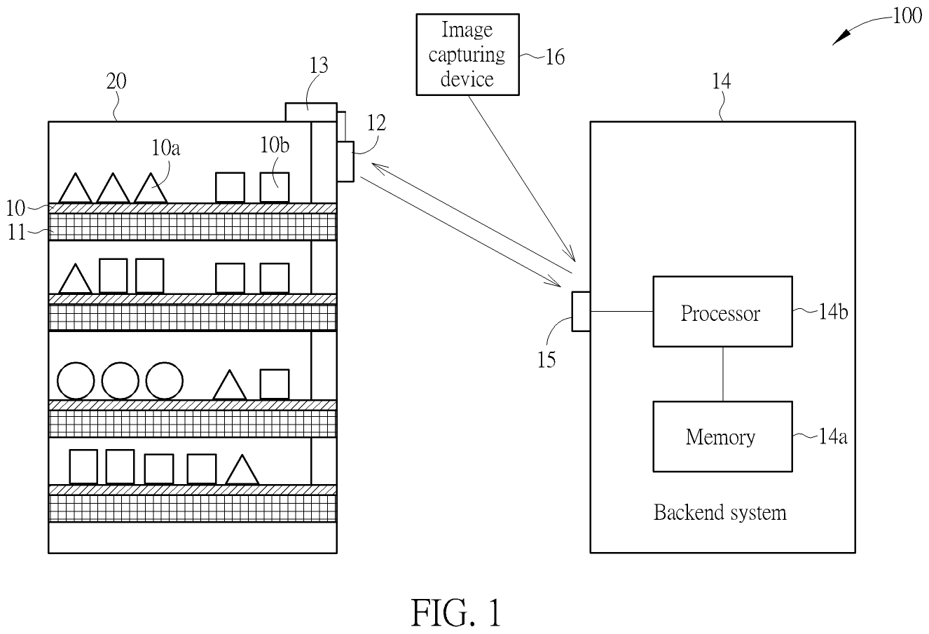

FIG. 1 is a block diagram of a product detection system 100 according to an embodiment of the present invention. The product detection system 100 includes a shelf laminate 10, a plurality of sensors 11, a transceiver 12, and a processor 13. The shelf laminate 10 is used for placing a plurality of products 10a and 10b. In the product detection system 100, a plurality of shelf laminates 10 can be introduced. These shelf laminates 10 can be used for placing identical or different products, as shown in FIG. 1. The plurality of sensors 11 are adjacent to the shelf laminate 10 for detecting if a product of the plurality of products 10a and 10b is picked up. The plurality of sensors 11 can be any type of signal sensors, such as an infrared sensor or an ultrasonic sensor. The transmitter 12 is used for transmitting and receiving data. The processor 13 is coupled to the plurality of sensors 11 and the transmitter 12 for controlling the plurality of sensors 11 and the transmitter 12. The processor 13 can be any processing element, such as a microprocessor or a processing chip. In the product detection system 100, when the plurality of shelf laminates 10 are introduced for placing the identical or different products, the plurality of shelf laminates 10, the plurality of sensors 11, the transmitter 12, and the processor 13 can be disposed into a smart shelf 20. In other words, the smart shelf 20 is capable of processing data and establishing network links. In the product detection system 100, after the processor 13 acquires an image including the shelf laminate 10 and the plurality of products 10a and 10b placed on the shelf laminate 10, the processor 13 acquires position information of a product of the plurality of products 10a and 10b according to the image. The processor 13 controls the plurality of sensors 11 for detecting an event of the product for generating a plurality of detection results. Then, the processor 13 determines the sales status of the product according to the position information of the product disposed on the shelf laminate 10 and the plurality of detection results.

Further, the product detection system 100 can include a backend system 14. The backend system 14 is linked to the transceiver 12 and/or an image capturing device 16 for receiving the image transmitted from the transceiver 12 and/or receiving the image transmitted from the image capturing device 16. The backend system 14 can acquire range information, coordinates information, and/or volume information of the product of the plurality of products according to the image. Further, the backend system 14 can include a memory 14a, a processor 14b, and a transceiver 15. The transceiver 15 is used for communicating data with the transceiver 12 of the smart shelf 20. The memory 14a can buffer data and can store product model data, product size data, and product appearance data of the smart shelf 20. The processor 14b is capable of processing the image and is coupled to the transceiver 15 and the memory 14a. In the product detection system 100, the image capturing device 16 (i.e., such as a camera) can take at least one picture of the entire smart shelf 20 or one shelf laminate 10 of the smart shelf 20 for placing the products 10a and 10b. The image capturing device 16 can transmit the image to the transceiver 15 of the backend system 14 through a wired or a wireless link. After the transceiver 15 receives the image, the transceiver 15 can transmit the image to the processor 14b for processing an image recognition function. Since the memory 14a has the product model data, the product size data, and the product appearance data, the processor 14b can acquire range information, coordinates information, and/or volume information of the product placed on the shelf laminate 10 according to the image. Then, the backend system 14 transmits the range information, the coordinates information, and/or the volume information to the processor 13 of the smart shelf 20 through the transceiver 15. Therefore, the processor 13 of the smart shelf 20 can acquire the position information of each product placed on the shelf laminate 10. Briefly, the image capturing device 16 can transmit the image to the backend system 14. The backend system 14 can process the image for generating the position information of the products 10a and 10b placed on the shelf laminate 10. Then, the backend system 14 can transmit the position information of the products 10a and 10b placed on the shelf laminate 10 to the processor 13 of the shelf laminate 10. By doing so, the processor 13 can acquire the position information of the products 10a and 10b placed on the shelf laminate 10. However, if the processor 13 pre-stores the image of the products of the smart shelf 20, the image can be directly transmitted to the backend system 14 through the transceiver 12 and the transceiver 15 for processing the image. Any reasonable technology modification falls into the scope of the present invention. Details of the plurality of sensors 11 of the shelf laminate 10 and a method for detecting an event of the product by using the plurality of sensors 11 are illustrated later.

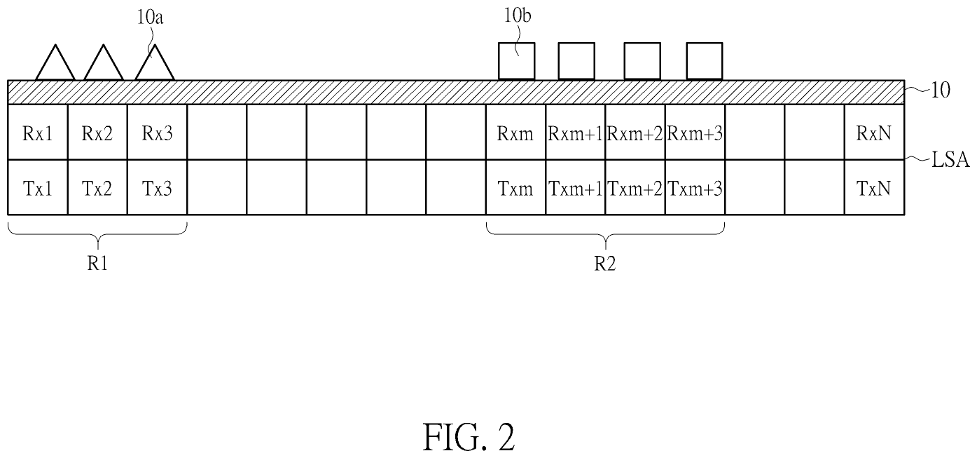

FIG. 2 is an illustration of a linear sensor array LSA and allocation ranges R1 and R2 of the products 10a and 10b placed on the shelf laminate 10 of the product detection system 100. Here, the plurality of sensors 11 can be placed along an allocated direction (i.e., an X-axis direction) of the plurality of products 10a and 10b placed on the shelf laminate 10 to form the linear sensor array LSA. For example, the linear sensor array LSA can include N sensors 11. A distance between two adjacent sensors 11 can be a predetermined constant, or can be a user-defined value. Each sensor 11 has a pair-wised transmitter and receiver. For example, a transmitter of the first sensor can be denoted as Tx1. A receiver of the first sensor can be denoted as Rx1. A transmitter of the second sensor can be denoted as Tx2. A receiver of the second sensor can be denoted as Rx2, and so on. A transmitter of the N^{th} sensor can be denoted as TxN. A receiver of the N^{th} sensor can be denoted as RxN. A transmitter of each sensor 11 is used for emitting a detection signal, such as periodically emitting an infrared signal or an ultrasonic signal. A receiver of each sensor 11 is used for receiving a reflected signal. As previously mentioned, the backend system 14 can acquire the range information, the coordinates information, and/or the volume information of each product of the plurality of products according to the image. Therefore, for the processor 13 of the smart shelf 20, the processor 13 can acquire an allocation range of each type of product placed on the shelf laminate 10 and can acquire at least one sensor index corresponding to the range of each type of product. For example, the allocation range of the plurality of products 10a is denoted as R1. A plurality of sensors 11 corresponding to the allocation range R1 can include transmitters Tx1 to Tx3 and receivers Rx1 to Rx3. The allocation range of the plurality of products 10b is R2. A plurality of sensors 11 corresponding to the allocation range R2 can include transmitters Txm to Txm+3 and receivers Rxm to Rxm+3. However, for the processor 13, it can also acquire an allocation range of a specific type of products placed on the shelf laminate 10 and at least one sensor index corresponding to the allocation range of the specific type of products. Any reasonable technology modification falls into the scope of the present invention.

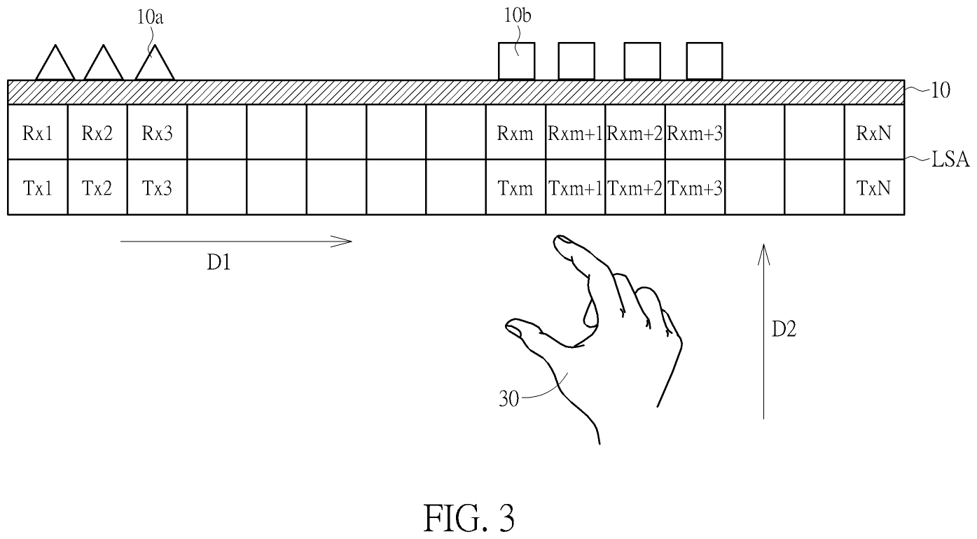

FIG. 3 is an illustration of a gesture of picking up a product in the product detection system 100. Here, users can use their hands for picking up the products or use other tools (i.e., such as a clip) for picking the products. The “pickup” event is triggered when the product is picked up. However, for simplicity, using the hands for picking up the products is illustrated in FIG. 3. As previously mentioned, the plurality of sensors 11 can be placed along an allocated direction of the plurality of products 10a and 10b placed on the shelf laminate 10 to form the linear sensor array LSA. For example, the plurality of sensors 11 can be placed along a first direction D1. A pickup path is acquired along a second direction D2. The first direction D1 and the second direction D2 are different. For example, the first direction D1 and the second direction D2 can be perpendicular or non-perpendicular to each other. The processor 13 can detect interference of sensing signals emitted from the plurality of sensors 11 for detecting the event of touching the product when the sensing signals are blocked by an object of the pickup path along the second direction D2. For example, as shown in FIG. 3, when a user's hand moves along the second direction D2 for picking up the product 10b, transmitters Txm to Txm+3 corresponding to the allocation range R2 and receivers Rxm to Rxm+3 of the linear sensor array LSA are gradually blocked. As previously mentioned, the sensing signals can be periodically emitted from the transmitter Tx1 to TxN. When some sensing signals emitted from the transmitter Txm to Txm+3 are blocked by the user's hand, these sensing signals emitted from the transmitter Txm to Txm+3 become reflected signals. Therefore, the receivers Rxm to Rxm+3 can receive the reflection signals having high energy. However, in the linear sensor array LSA, since remaining sensing signals transmitted from transmitters of remaining sensors 11 are unblocked, power levels of corresponding reflected signals received by receivers of the remaining sensors 11 are very small. In other words, the processor 13 can determine range information, location information, and time duration information of the user's gesture according to a power distribution of the reflected signals received by the linear sensor array LSA when the user wants to pick up the product. Further, since the processor 13 can determine the range information, the location information, and the time duration information of the user's gesture of picking up the product, the sales status of the product can be analyzed. Details of analyzing the sales status of the product are described below.

In FIG. 3, when sensing signals emitted from the transmitters Txm to Txm+3 corresponding to the product 10b are blocked during a first time interval, the product 10b corresponds to a first sales status. When sensing signals emitted from the transmitters Txm to Txm+3 corresponding to the product 10b are blocked during a second time interval, the product 10b corresponds to a second sales status. For example, if the user takes a lot of time to pick up the product 10b placed on the shelf laminate 10 by hand, it implies that the product 10b is hard to be reached. Therefore, it is implied that the sales status of the product 10b is good. If the user takes a short time to pick up the product 10b placed on the shelf laminate 10 by hand, it implies that the product 10b can be reached easily. Therefore, it is implied that the sales status of the product 10b is bad. In other words, when a length of the first time interval is greater than a length of the second time interval, the first sales status is better than the second sales status. Therefore, the detection system 100 is capable of determining the sales status of specific products.

Further, as previously mentioned, if the user takes a lot of time to pick up the product 10b placed on the shelf laminate 10 by hand, it implies that the product 10b is hard to be reached. It also implies that the product 10b is placed at a deep position of the shelf laminate 10. Since the product 10b is placed at the deep position of the shelf laminate 10, it implies that a remaining amount of the products 10b is small. If the user takes a short time to pick up the product 10b placed on the shelf laminate 10 by hand, it implies that the product 10b is easily reachable. It also implies that the product 10b is placed at an edge position of the shelf laminate 10. Since the product 10b is placed at the edge position of the shelf laminate 10, it implies that a remaining amount of the products 10b is large. In other words, the first time interval corresponds to a first remaining amount of products 10b placed on the shelf laminate 10. The second time interval corresponds to a second remaining amount of products 10b placed on the shelf laminate 10. When the length of the first time interval is greater than the length of the second time interval, the first remaining amount is less than the second remaining amount. Therefore, the detection system 100 is capable of determining the remaining amount of the specific products.

Further, the detection system 100 is capable of determining a popularity of a specific product. For example, the processor 13 can control the plurality of sensors 11 for detecting the event to determine the popularity of the product according to a blocking range of the plurality of sensors 11. When a first blocking range is detected by the plurality of sensors 11, the product is determined as being touched by the processor 13. The product has a first popularity. When a second blocking range is detected by the plurality of sensors 11, the product is determined as being untouched by the processor 13. The product has a second popularity. Here, the first blocking range is greater than the second blocking range. The first popularity is higher than the second popularity. In other words, when the product is determined as being touched, it implies that the user pays more attention to the product. Therefore, the product can be regarded as a popular product. Conversely, when the product is determined as being untouched, it implies that the user pays less attention to the product. Therefore, the product can be regarded as an unpopular product.

Further, the detection system 100 is capable of detecting a pickup count of the product by using the plurality of sensors 11 adjacent to the shelf laminate 10. For example, according to statistical data, when the product is touched, a chance of picking up the product is 80%. Therefore, the processor 13 can estimate the pickup count of the product according to a touched count of the product. The detection system 100 can record the pickup count of the product. Further, after the sales status of the product is generated by the processor 13, the sales status can be transmitted to the backend system 14 through the transceiver 12 and the transceiver 15. After the backend system 14 receives the sales status of the product, a manager can control the backend system 14 for generating a marketing strategy according to the sales status. For example, when a remaining amount of products is too small and inventories are insufficient, the backend system 14 can generate a “replenishment” marketing strategy. When there are too many remaining and unsalable products placed on the shelf laminate 10, the backend system 14 can generate a “limited-time specials” marketing strategy. Further, the products can also be reallocated on conspicuous places for stimulating consumption.

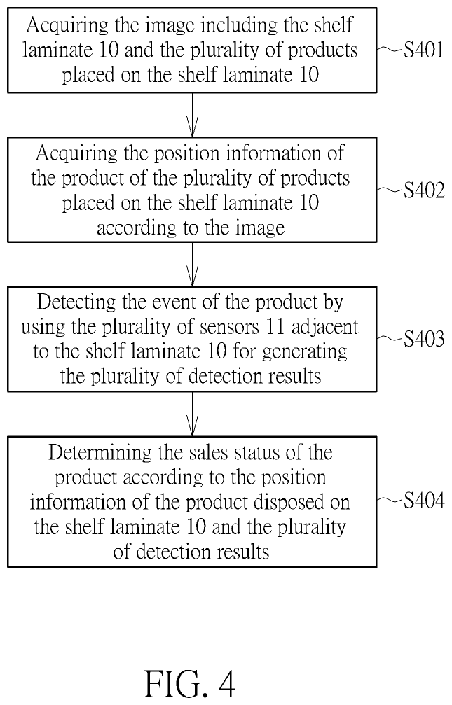

FIG. 4 is a flow chart of a product detection method performed by the product detection system 100. The product detection method performed by the product detection system 100 includes step S401 to step S404. Any reasonable technology modification falls into the scope of the present invention. Step S401 to step S404 are illustrated below.
step S401: acquiring the image including the shelf laminate 10 and the plurality of products placed on the shelf laminate 10;
step S402: acquiring the position information of the product of the plurality of products placed on the shelf laminate 10 according to the image;
step S403: detecting the event of the product by using the plurality of sensors 11 adjacent to the shelf laminate 10 for generating the plurality of detection results;
step S404: determining the sales status of the product according to the position information of the product disposed on the shelf laminate 10 and the plurality of detection results.

Details of step S401 to step S404 are previously illustrated. Thus, they are omitted here. The product detection system 100 can detect the event (i.e., a touched event or an untouched event) of the product for determining the sales status of the product according to step S401 to step S404. Since no manpower is required for performing step S401 to step S404, the product detection system 100 can automatically generate the sales status to the backend system. By doing so, the manager of the backend system can easily determine the marketing strategy of the product.

To sum up, the present invention discloses a product detection method and a product detection system. The product detection system is capable of determining an event, a remaining amount, and a popularity of specific products. The product detection system can use a linear sensor array for detecting a blocked range and a length of a blocked interval when a user wants to pick up the product by hand. Instead of executing a patrolling process by the service staff for acquiring a sales status, the product detection system can automatically generate the sales status to a backend system. Therefore, the product detection system of the present invention can reduce manpower consumption and can increase an efficiency of product sales management.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A product detection method comprising:
acquiring an image comprising a shelf laminate and a plurality of products placed on the shelf laminate;
acquiring position information of a product of the plurality of products according to the image;
detecting an event of the product by using a plurality of sensors adjacent to the shelf laminate for generating a plurality of detection results; and
determining a sales status of the product according to the position information of the product disposed on the shelf laminate and the plurality of detection results.

2. The method of claim 1, wherein acquiring the position information of the product of the plurality of products according to the image, is acquiring range information, coordinates information, and/or volume information of the product of the plurality of products according to the image.

3. The method of claim 1, further comprising:
placing the plurality of sensors along a first direction;
acquiring a pickup path along a second direction; and
detecting interference of sensing signals emitted from the plurality of sensors for detecting the pickup action of touching the product;
wherein the sensing signals are blocked by an object of the pickup path along the second direction.

4. The method of claim 1, wherein when a sensing signal corresponding to the product is blocked during a first time interval, the product corresponds to a first sales status, when the sensing signal corresponding to the product is blocked during a second time interval, the product corresponds to a second sales status, and when a length of the first time interval is greater than a length of the second time interval, the first sales status is better than the second sales status.

5. The method of claim 4, wherein the first time interval corresponds to a first remaining amount of products placed on the shelf laminate, the second time interval corresponds to a second remaining amount of products placed on the shelf laminate, and when the length of the first time interval is greater than the length of the second time interval, the first remaining amount is less than the second remaining amount.

6. The method of claim 1, wherein the event is triggered when the product is picked up, and the plurality of sensors are placed along an allocated direction of the plurality of products placed on the shelf laminate to form a linear sensor array.

7. The method of claim 1, further comprising:
determining popularity of the product according to a blocking range of the plurality of sensors when the event is detected;
wherein when a first blocking range is detected by the plurality of sensors, the product is determined as being touched, and the product has a first popularity, and when a second blocking range is detected by the plurality of sensors, the product is determined as being untouched, and the product has a second popularity; and
wherein the first blocking range is greater than the second blocking range, and the first popularity is higher than the second popularity.

8. The method of claim 1, further comprising:
detecting a pickup count of the product by using a plurality of sensors adjacent to the shelf laminate; and
recording the pickup count of the product.

9. The method of claim 1, further comprising:
transmitting the sales status to a backend system after the sales status of the product is generated; and
generating a marketing strategy by the backend system according to the sales status.

10. The method of claim 1, further comprising:
transmitting the image to a backend system;
processing the image by the backend system for acquiring the position information of the product placed on the shelf laminate; and
transmitting the position information of the product placed on the shelf laminate to a processor of the shelf laminate.

11. A product detection system comprising:
a shelf laminate configured to place a plurality of products;
a plurality of sensors adjacent to the shelf laminate and configured to detect if a product of the plurality of products is picked up;
a transmitter configured to transmit and receive data; and
a processor coupled to the plurality of sensors and the transmitter and configured to control the plurality of sensors and the transmitter;
wherein after the processor acquires an image comprising the shelf laminate and the plurality of products placed on the shelf laminate, the processor acquires position information of a product of the plurality of products according to the image, the processor controls the plurality of sensors for detecting an event of the product for generating a plurality of detection results, and the processor determines a sales status of the product according to the position information of the product disposed on the shelf laminate and the plurality of detection results.

12. The system of claim 11, further comprising:
a backend system linked to the transceiver and configured to receive the image transmitted from the transceiver, and configured to acquire range information, coordinates information, and/or volume information of the product of the plurality of products according to the image;
wherein the backend system transmits the range information, the coordinates information, and/or the volume information to the processor.

13. The system of claim 11, wherein the plurality of sensors are placed along a first direction, a pickup path is acquired along a second direction, the processor detects interference of sensing signals emitted from the plurality of sensors for detecting the pickup action of touching the product, and the sensing signals are blocked by an object of the pickup path along the second direction.

14. The system of claim 11, wherein when a sensing signal corresponding to the product is blocked during a first time interval, the product corresponds to a first sales status, when the sensing signal corresponding to the product is blocked during a second time interval, the product corresponds to a second sales status, and when a length of the first time interval is greater than a length of the second time interval, the first sales status is better than the second sales status.

15. The system of claim 14, wherein the first time interval corresponds to a first remaining amount of products placed on the shelf laminate, the second time interval corresponds to a second remaining amount of products placed on the shelf laminate, and when the length of the first time interval is greater than the length of the second time interval, the first remaining amount is less than the second remaining amount.

16. The system of claim 11, wherein the event is triggered when the product is picked up, and the plurality of sensors are placed along an allocated direction of the plurality of products placed on the shelf laminate to form a linear sensor array.

17. The system of claim 11, wherein:
the processor controls the plurality of sensors for detecting the event to determine popularity of the product according to a blocking range of the plurality of sensors, when a first blocking range is detected by the plurality of sensors, the product is determined as being touched, and the product has a first popularity, and when a second blocking range is detected by the plurality of sensors, the product is determined as being untouched, and the product has a second popularity; and
the first blocking range is greater than the second blocking range, and the first popularity is higher than the second popularity.

18. The system of claim 11, wherein the processor detects a pickup count of the product by using a plurality of sensors adjacent to the shelf laminate, and records the pickup count of the product.

19. The system of claim 11, further comprising:
a backend system linked to the transceiver;
wherein after the sales status of the product is generated by the processor, the sales status is transmitted to the backend system, and the backend system generates a marketing strategy according to the sales status.

20. The system of claim 11, further comprising:
a backend system linked to the transceiver;
wherein the processor transmits the image to the backend system through the transceiver, the backend system processes the image for acquiring the position information of the product placed on the shelf laminate, and the backend system transmits the position information of the product placed on the shelf laminate to the processor.
